(19) United States
(12) Patent Application Publication
(10) Pub. No.: US 2014/0212851 A1
(43) Pub. Date: Jul. 31, 2014

(54) Titles of my related inventions are Binary Mixed Equations, Binary-School Cards, Binary Quads Puzzles and Binary Quads Games.

(71) Applicant: Coygon Robinson, Jr., Oakland, CA (US)

(72) Inventor: Coygon Robinson, Jr., Oakland, CA (US)

(21) Appl. No.: 13/754,626

(22) Filed: Jan. 30, 2013

(51) Int. Cl. G09B 23/02

(52) U.S. Cl. CPC G09B 23/02
USPC 434/188

(57) ABSTRACT

My Binary Mixed Equation is a new math equation format and my Binary Quads Puzzles, Binary Quads Games and Binary-School Cads are new math related instructional aids I created to introduce students to the world of Base Two numbers, while reinforcing their math kills. I used Binary Coded Decimal number sequences of ones (1) and zeros (0) to represent decimal numbers within a traditional equation format. I then created my Binary Quads Puzzles and Games by combining my Binary Mixed Equations and traditional equations into mathematically functional equation based puzzle designs. I developed a process of individually pivoting a group of equations from their traditional horizontal orientation and then rotating each of them to different angles from 0 to 360 degree before arranging each equation within a crisscrossing, intersecting and bisecting design to create multiple puzzle designs that are functional, instructive and recreational.

### CROSS-REFERENCE TO RELATED APPLICATIONS

“NOT APPLICABLE”

### STATEMENT REGARDING FEDERALLY SPONSORED RESEARCH OR DEVELOPMENT

“NOT APPLICABLE”

### REFERENCE TO SEQUENCE LISTING, A TABLE, OR A COMPUTER PROGRAM LISTING COMPACT DISC APPENDIX

“NOT APPLICABLE”

### BACKGROUND OF THE INVENTION

All of the puzzles and games listed in this patent application was created using my Binary Mixed Equation math problem format. Binary Mixed Equations are basically equations created by adding Binary Coded Decimal number sequences of ones (1) and zeros (0) to the list of all possible numbers, signs, symbols and functions used in mathematics to creation a traditional equation. I then used these equations to create my Binary-School Cards and a variety of other puzzle configurations by combining Binary Mixed Equations with traditional horizontal equations. I created the puzzle design by first pivoting these equations at their starting point and then rotating each of them to a different angle from 0 to 360 degrees. These rotated equations are then rearranged into a design of equations that crisscross, intersect and bisect each other to form my Binary Quads Puzzle format. These Binary Quads Puzzles are the foundations on which all of my Binary Quads Games were built.

My inspiration for creating my Binary Mixed Equations, Puzzles and Games can about during the two years I spent working as a full-time Site Substitute Teacher at James Denman Middle School in San Francisco. For years I had sought a way to share some of what I had learned serving in the Air Force as a Electronic Communication Analyst. soon realized that the time I was spending with students in each classroom and monitoring them around the school grounds had given me new insight into the need for more connectivity between a school's curriculum and real world applications.

I later discovered the Science, Technology Engineering Mathematic (STEM) initiative and began researching ways I could blend some of my practical and operational experience as a supervisor and trainer of communication analysts with the science and math curriculum being taught in our schools today. The ideas for my Binary Mixed Equations, Binary Quads Puzzles and Games can out of my research and contemplation on the issue. I saw my puzzles and games as additional and supportive resource material for the instructional modules and lessons I had started developing for my Technology Preparatory Program (Tech-PreP).

My original intent for creating my Binary Mixed Equation formats was to provide students with a fun way to reinforce basic math skills, while teaching them about the fundamental of modern communication practices. However, my unchecked curiosity and imagination took hold of me and the results has been the development of my puzzles and games. My Binary Mixed Equations is actually the second communication related puzzle and game platform, which I have developed to help students bridge the current gap between the math and science curriculums and their technical applications. These puzzles and games deals with codes and are designed to start preparing students for careers in the programming side of communication. Using Cryptographs In Education module outline was a part of the 2011 copyrighted I received under my Technology Preparatory Program (Tech-PreP).

### BRIEF SUMMARY OF THE INVENTION

Binary Mixed Equations—Binary Mixed Equations are basically equations created using elements from an expanded list of the numbers, signs, symbols and function used in mathematics to creation a traditional equation. I added Binary Coded Decimal number sequences of ones (1) and zeros (0) as substitutes for decimal numbers within the equations to challenge students to learn more about the Base Two Number System. I believe the addition of binary numbers into the equation format constitutes a new and patentable invention.

Binary Quads Puzzles—These puzzles are composed of a combination of two or more Binary Mixed Equations and, or traditional equations arranged on a graph paper type grid of quads (squares). These equations are then used to create a variety of puzzle configurations by combining traditional horizontal equations with individual equations which I have pivoted at their starting points and then rotated to different angles from 0 to 360 degrees. These individual equations are then rearranged into a design of equations that crisscross, intersect and bisect each other to form my Binary Quads Puzzle format. These puzzles serve as the face and foundation of all my Binary Games.

Binary Quads Games—These games are basically Binary Quads Puzzles placed on the main game boards and player's cards. I have created score sheets, claim cards, rules and instructions to support the playing the game.

Binary-School Cards—These cards are actually tutorials which I created to help students practice solving Binary Mixed Equations. Each card is composed of four basic horizontally oriented Binary Mixed Equations and six numbered blank lines of quads for students to practice creating their own equations.

### BRIEF DESCRIPTION OF THE SEVERAL VIEWS OF THE DRAWING

(There are 15 figures in this section.)

FIG. 1, Basic Binary Mixed Equations and Conversion Lines—This figure illustrates the basic design of Binary Mixed Equations, which can contain decimal numbers, math signs and functions, and Binary Coded Decimal numbers sequence of ones (1) and zeros (0). The second row of equations reveals the binary to decimal conversions of the top equation and the final answer to that equation.

FIG. 2, Binary To Decimal Conversion—This figure illustrates how the positions of the digits in a Binary Coded Decimal number sequence of ones (1) and zeros (0) are numerically weighted from right to left in a doubling pattern (32, 16, 8, 4, 2, 1). The conversion process requires that all values of the positions containing a binary 1 must be added together to reveal the decimal equivalent of that binary number sequence.

FIG. 3, Binary School Cards Tutorial 04—There are tutorial and standard versions of Binary School Cards each containing four pre-printed horizontally oriented Binary Mixed Equations and six blank sections of quads. All of the binary sequences are marked with Identity Question (IQ) numbers to record the student's answers on the Tech-PreP Answer Sheet, reference FIG. 11.

FIG. 4, Binary School Cards Tutorial 04—INS—All Instructor's Notes (INS) versions of my Binary School Cards are copies of the original cards. However, the Instructor's Notes versions of the Binary-School Cards will also have shaded or colored quads, containing the corresponding answers to each Identity Question on that card.

FIG. 5, The Pivoting and Directional Changes of Equations—The arrows in this diagram illustrates how the designer of Binary Quads Puzzles can change the orientation of equations by pivoting and rotating each equation to a different angle from zero to 360 degrees. The 135, 90 and 45 degree equations are examples of directional changes.

FIG. 6, Binary Quads Puzzle 01—This puzzle is the first in my Binary Quads Puzzle series. This skill level 01 design uses the equation pivoting and rotation technique, which I illustrated in FIG. 5. All Binary Quads Game Puzzles are printed as separate sheets and applied to the games with rowed back taping technique. These may contain all of the following features depending of the skill level of its design. The arrows will indicate the final orientation of each equation. The intersecting quads that are common to the crisscrossing equations must be a functional part of both equations. Puzzle 01 also introduces blank quads within the equations to conceal the identity of parts of the equation. The numbered and bordered quads mark the Identity Questions (IQ), which are binary sequences and blank squares that must be identified by the students or players in order to complete the equation. The answers to these IQs are recorded on my Tech-PreP Answer Sheet in FIG. 11. The skill levels of puzzles are assigned by the number of arrows, bisects and r intersections, blank quads, signs such as), π, ≦, ≧, # and (, and other functions, are used creating the puzzle.

FIG. 7, Binary Quads Game Board—The Binary Quads Puzzle is the face of all my binary game boards. This particular puzzle has a skill level 4 design. All of the equations in these more advanced designs are highlighted or colored to define the directions of the individual equations. Any blank quads in these equations are either not highlighted or colored, or they are given a darker shade of highlight. The outer border of these puzzles can be the shape of any polygon. However, the border shape selected must neatly match the quad filled grid which fills the interior space. I have selected a basic square border for this patent application, with the game board scaled at 11.5″×11.5″, however, I have included an alternate version in FIG. 9 for your review. The board design includes capitol letters from left to right along the top to label the columns and numbers to label the rows down the right side of the square borders of the puzzle. The Binary Quads name appears centered and facing out along all four sides of the game board. The BQ logo is diagonally placed facing outward in each corner of the board. FIG. 15, INS/GM Answer Sheet contains the answers to this puzzle.

FIG. 8, Binary Quads Challenge Game Board—The Binary Quads Challenge Game Board is identical to the Binary Quads Game Board in FIG. 7, minus the pre-printed Binary Quads Puzzle, Identity Questions numbers and arrow indicators.

FIG. 9, Alternate Binary Quads Game Board Design—This is one of my alternate Binary Quads Game Board designs that shows my continued use of polygon shaped borders and tiles to create my game boards and game cards.

FIG. 10, Binary Quads Player's Cards—The puzzle face of Binary Quads Player's Cards are identical to its corresponding Binary Quads Game Boards.

FIG. 11, Tech-PreP Answer Sheet—This form is used to record a student's answers or to assign points to players from Identity Questions during Binary Quads Games.

FIG. 12, Equation Claim Slips, Inside—These slips contains a ID TAG Quad, Claimed Points Quad and four Equation Grid Lines. The first line is used for submitting new claims or an add-on to an existing equations. The next three grid lines are for challenging claims.

FIG. 13, Equation Claim Slips, Front Side—This is the front side of the Equation Claim Slips, which contains the title of the slips, a copyright message and my name.

FIG. 14, Player's Score Sheet—This sheet is used to label a players score column with their ID Tags and to record the points a player wins or loses during equation claims and challenges.

FIG. 15, INS/GM Answer Sheet—This form contains all the answers to a particular puzzle and is used by teachers and Game Masters to confirm the correctness of the answers to the Identity Questions (IQ) within a particular puzzle or game.

### DETAILED DESCRIPTION OF THE INVENTION

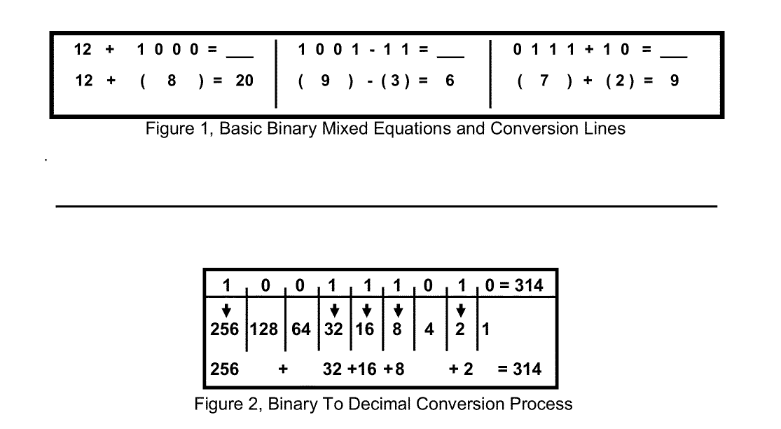

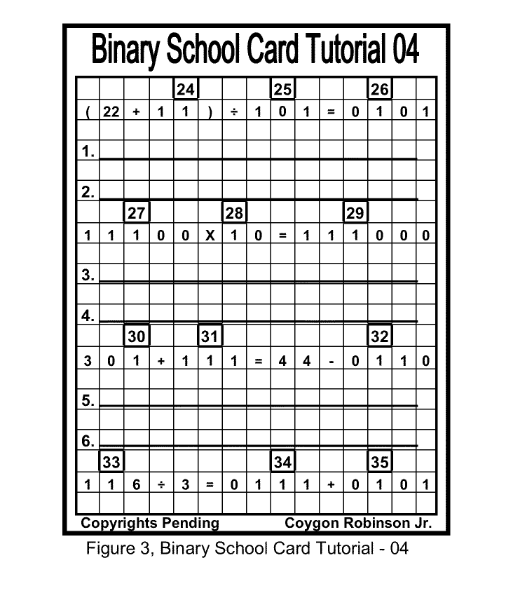

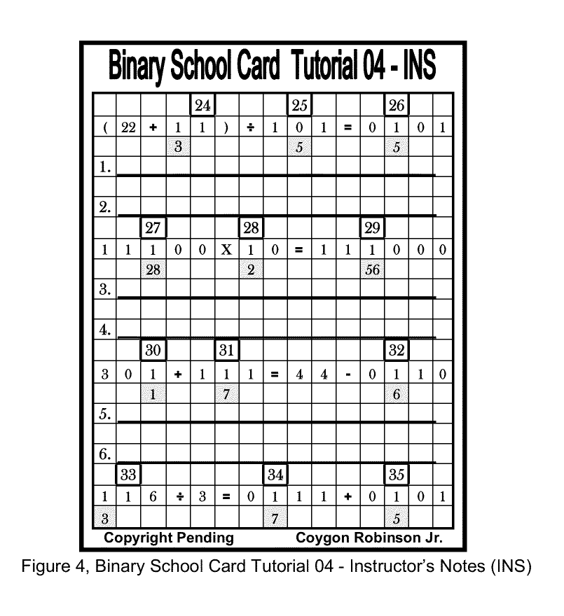

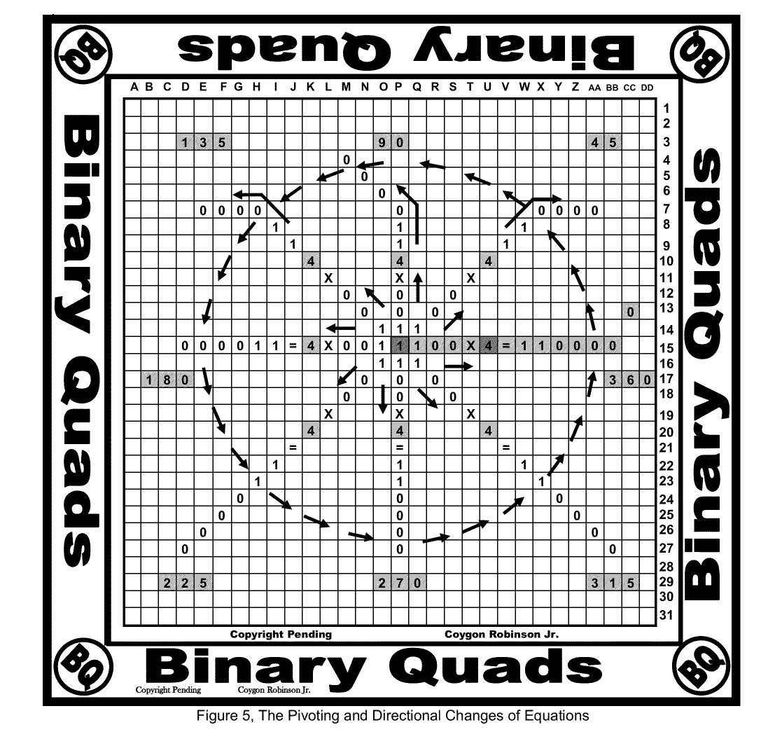

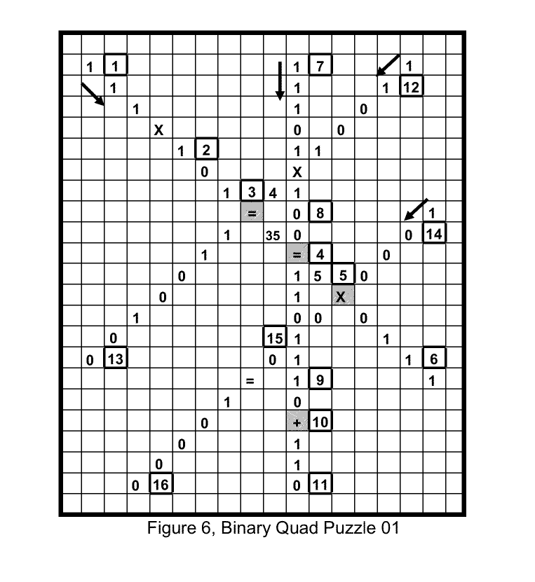

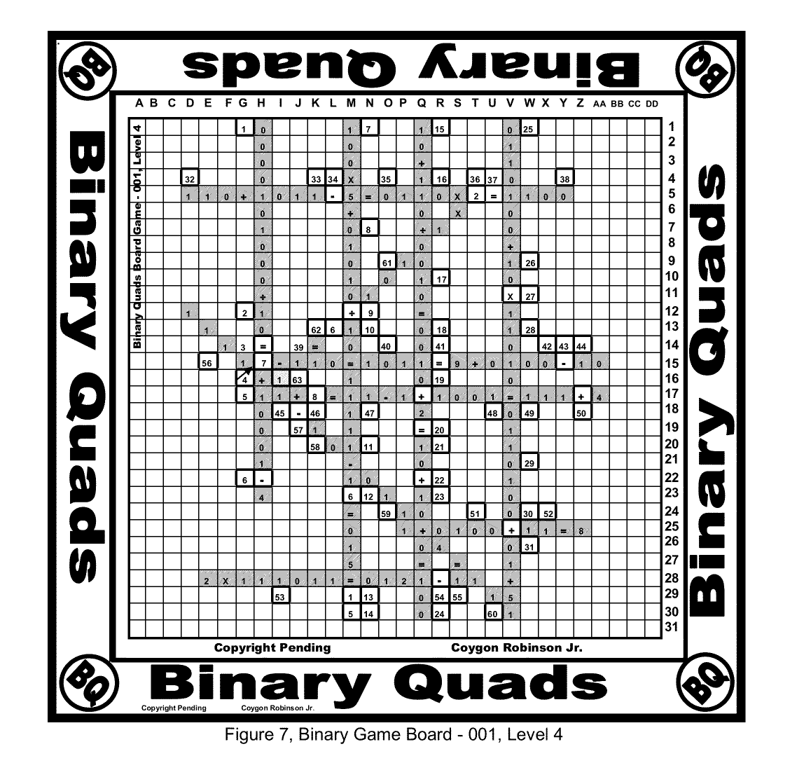

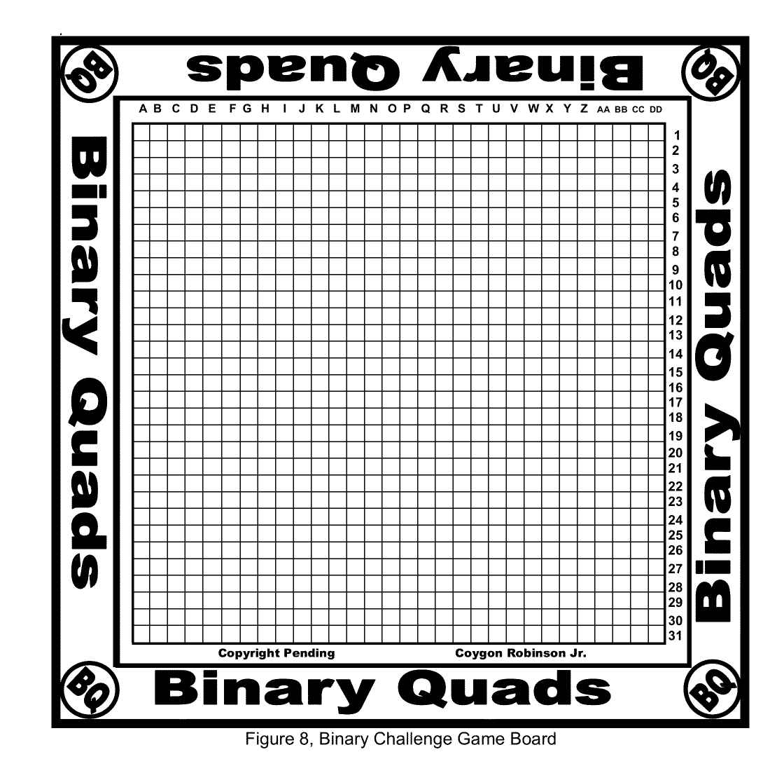

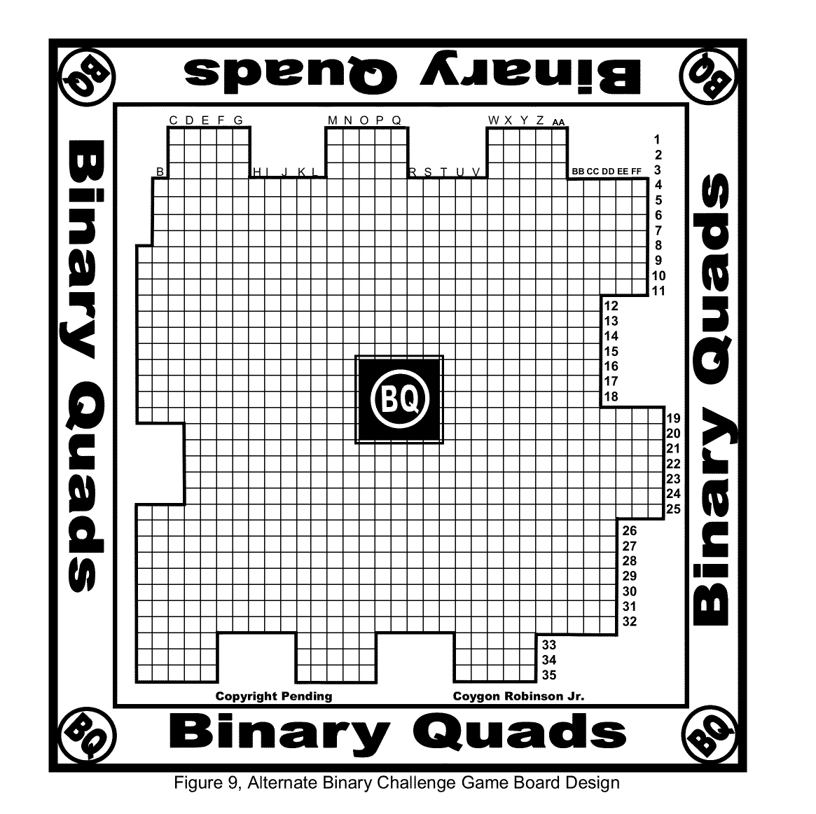

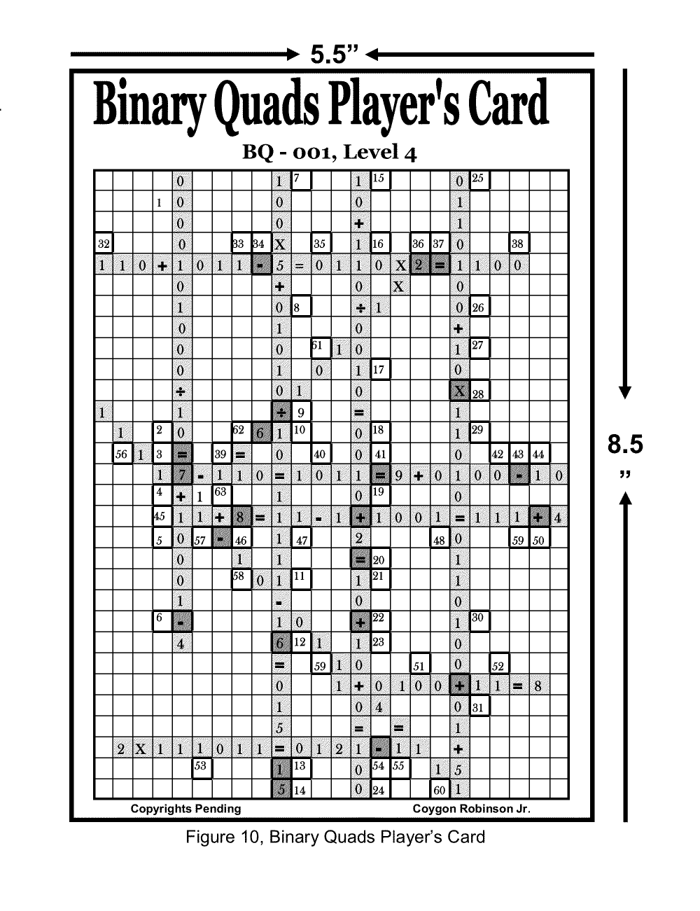

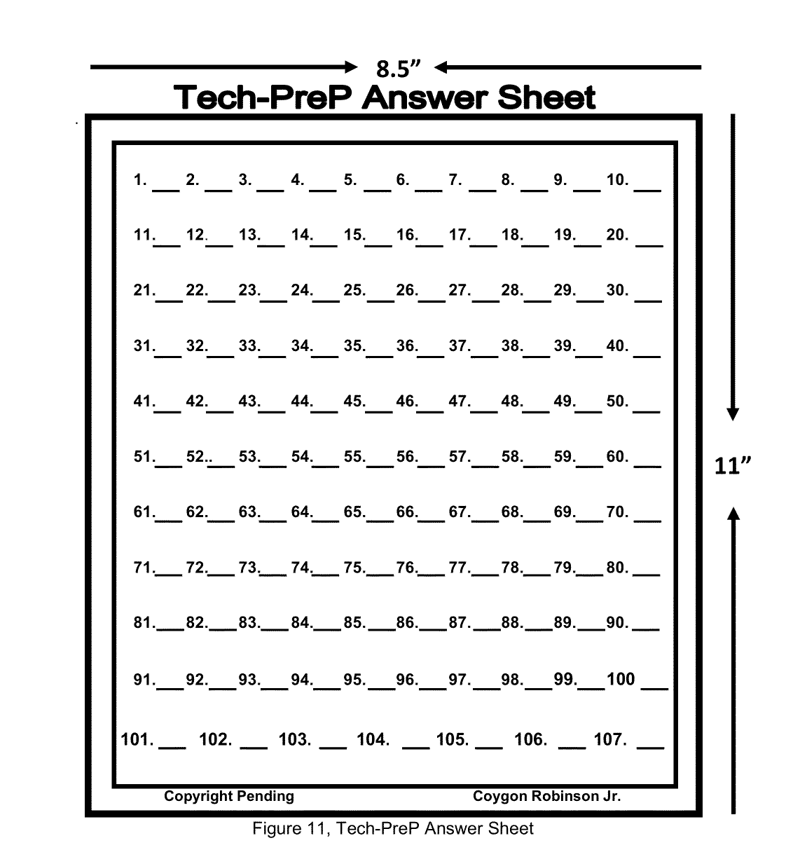

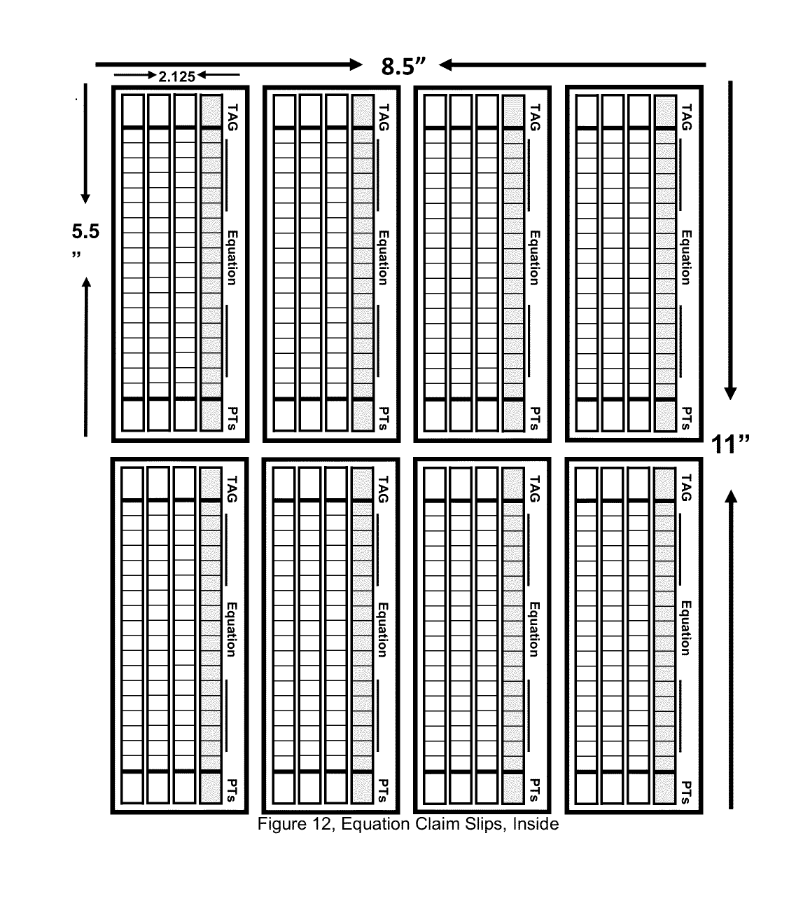

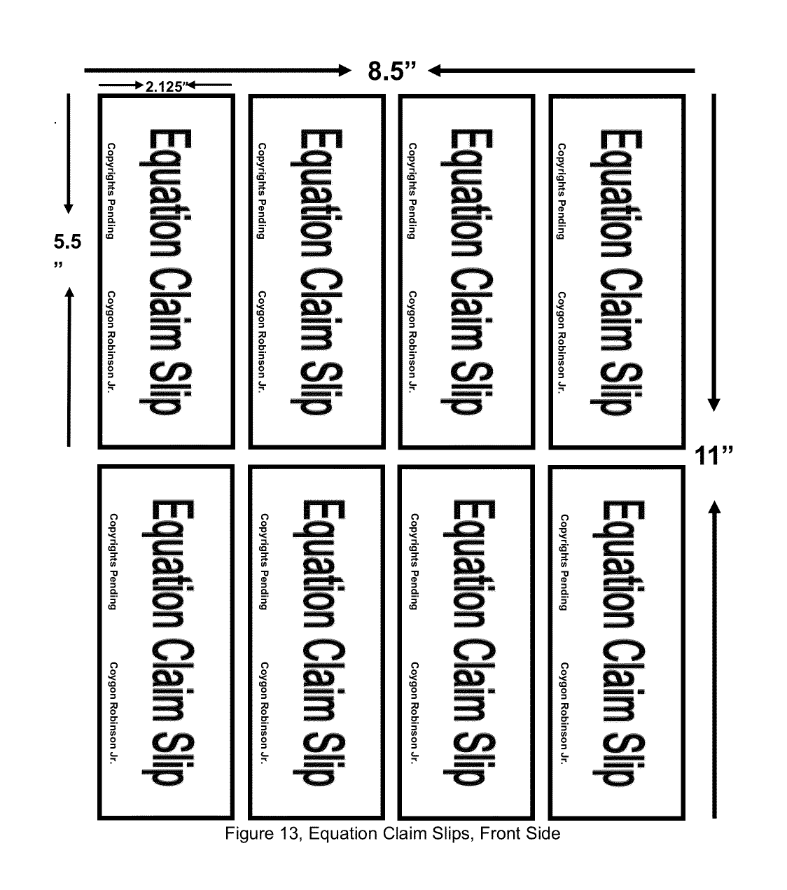

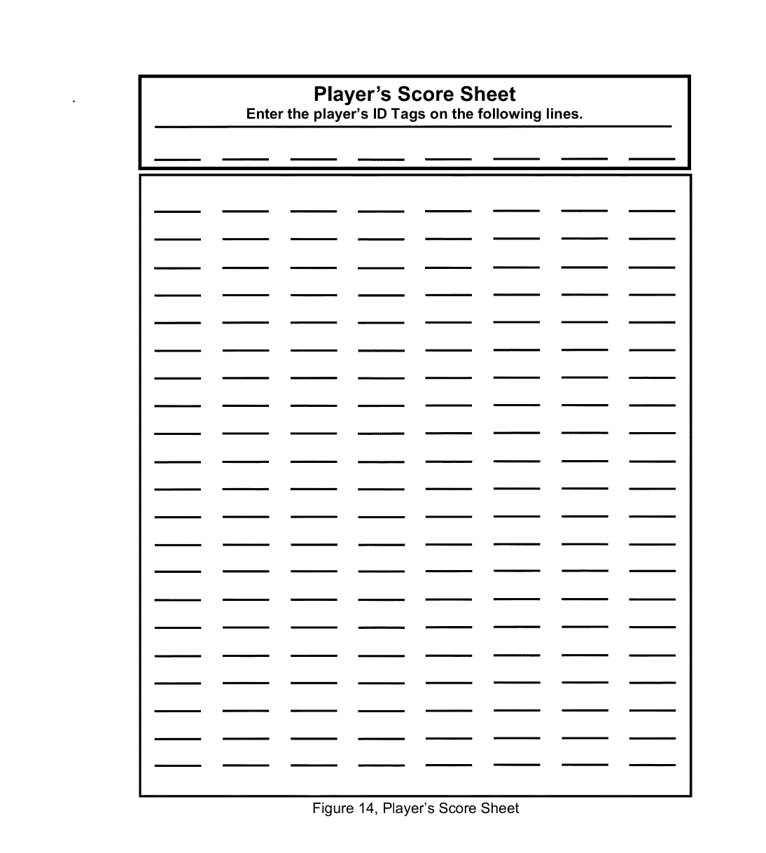

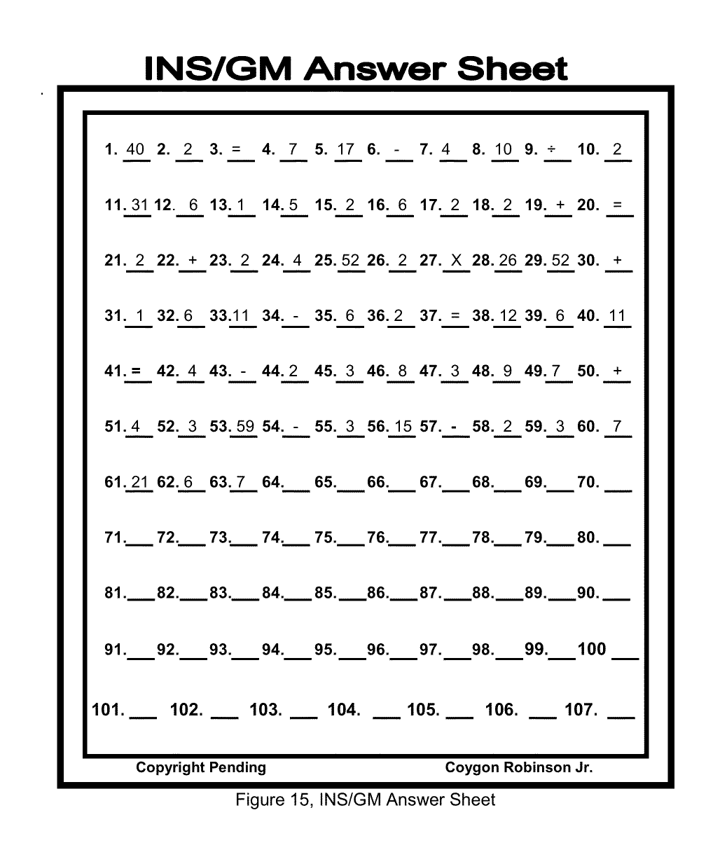

Inventing my Binary Mixed Equations also allowed my to invent my Binary-School Cards, Binary Quads Puzzles, and my Binary Quads Games and Cards.
Binary Mixed Equations—This is a unique equation concept I developed that uses Binary Coded Decimal number sequences of ones (1)s and zeros (0) to represent decimal numbers in the creation of traditional mathematical equations. This format offers unique opportunities to reinforce a student's basic to more complex math skills, while challenging them to determine whether a series of digits such as 1, 10, 11, 100, 101 or 110 are binary or decimal numbers. I believe it to a crucial responsibility of today's educators to introduce the binary system to students at the earliest moment in their education.
   FIG. 1, Basic Binary Mixed Equations and Conversion Lines illustrates an example of my basic Binary Mixed Equations. The top equation in the diagram has a mixture of binary and decimal numbers. The bottom equation reveals the conversion from binary to decimal numbers to allow the equation to be solved in the traditional manner.
   FIG. 2, Binary To Decimal Conversion Process is a brief tutorial of the Binary Coded Decimal conversion process. The diagram shows the right to left value weighting of the positions of the binary sequence. Note that only the value positions with a binary one are brought down and added together to arrive at the correct decimal number equivalent to that binary sequence, or binary number.
Binary-School Cards
   Binary-School Card Tutorial—These are tutorial puzzles designed to allow students to practice solving and creating Binary Mixed Equations. FIG. 3, Binary-School Card Tutorial-04, illustrates a sample of the card's format that includes four Binary Mixed Equations and six blank lines of quads for students to create their own equations. Each binary sequence within the Binary-School Card is labeled with a one up Identity Question (IQ) Number. Students will used the Tech-PreP Answer Sheet, FIG. 10, to record their answers during classroom activities. However, my Tech PreP Answer Sheets are more extensively used with my Binary Quads Games, including my Binary-School Cards when used in a game format, for awarding points by recording the player's Tag or initials by the IQ number on the form.
   Binary-School Cards, INS—This card is identical to the Binary-School Cards but I have included the answers to the IQ question as Instructor's Notes (INS) to help teachers and Game Masters manage classes and games play. Most of the answers to the IQ questions will be located across from or near the IQ's number location on the cards. See FIG. 4, Binary-School Card Tutorial 04 INS, Instructor's Notes.
Binary Quads Puzzles—These puzzles are more advanced versions of my Binary-School Cards. I created these puzzles by pivoting and rotating traditional equations and, or my Binary Mixed Equations at their starting points on the puzzle's grid surface and then arranging them in different ways to create a crisscrossing configuration of functional equations. See FIG. 5, The Pivoting and Directional Changes of Equations. This diagram shows how the equation (1 1 0 0× [symbol] =1 1 0 0 0 0), which is 12×4=48, can be pivoted and rotated to a different angle from zero to 360 degrees while maintaining its traditional left to right format. Directional arrows are placed at the start of all equations in a puzzle with the exception of the more advanced and challenge versions of my Binary Quads Puzzles and Games. The equations at angles 135, 90 and 45 within this figure shows how a player can change the direction of their equation during its creation. The puzzle in FIG. 6, Binary Quads 01 illustrates a standard Binary Quads Puzzle format with various vertical and diagonal equations with functional intersections shared between equations, blank squares, signs, functions and labeled with Identity Question Numbers.
Binary Quads Games—I created two Binary Quads Game formats, the Binary Quads Board Game and the Binary Quads Challenge Game, however, the Binary-School Cards can also be used to create a gaming environment. These games are basically Binary Quads Puzzle with special playing boards and cards, rules, scoring sheets, answer forms and claim processing slips. I use different polygon shapes to form The outer borders of the puzzle section of my Binary Quads Game Boards, Binary Quads Challenge Game Boards and BQ Player's Game Cards. FIG. 9, Alternate Binary Quad Game Board Design illustrates the flexibility polygons allows me in designing new puzzles and games.
   Binary Quads Main Board Game—The puzzle designed for this patent application uses a basic 11.5×11.5 square inch game board design. This square is filled with a grid of quads which has the appearance of standard sheets of graph paper. Only one character will be assigned to a single quad. I labeled the vertical columns of quads along the top border with capital letters from left to right. The rows are labeled with numbers down along the right side of the square puzzle section. FIG. 7, Binary Quads Game Board illustrates a skill level-4 Binary Quads Puzzle design. This puzzle contains five horizontal equations, four vertical equations and two diagonal oriented equations. There are 63 Identity Questions, 21 shaded blank quads and 5 bisects and 20 intersections between equations. There are no directional arrows included in this puzzle design because it is considered an high skill level puzzle. The skill levels of a pre-printed puzzle are determined by the number of Binary Mixed Equations, traditional equations, blank quads and equation intersections and bisects used to create the puzzle. A copies of the INS/GM Answer Sheets will be provided that contains all of the answers to IQ questions of a particular game board or card. See FIG. 10, Binary Quads Player's Cards and FIG. 15, INS/GM Answer Sheet, Example to BQGB-001.
   Binary Quads (BQ) Player's Card—The puzzles of these cards are exact duplicates of the puzzles in the companion Binary Quads Game Board. See FIG. 9, Binary Quads Player's Cards. The dimensions of the BQ Player's Cards for this patent application are 4.25″×11″. Larger puzzle sections may require larger player cards. A minimum of four BQ Player's Cards are created for each Binary Quads Game. Any reasonable number of players may participate in a game. The players use the cards as a visual guide to determine the answers to the numbered IQ questions, to create new mixed equations, to submit add-ons to the existing equations and to make challenges to the accuracy of another player's equation or add-on claims. The Equation Claim Slips are used to present these claims and challenges to the teacher or Game Master of a game. See FIG. 12, Equation Claim Slips, Inside and FIG. 13, Equation Claim Slips, Front.
Binary Quads Challenge Game—This is a open game format that uses a blank puzzle grid of quads with no pre-printed equations. The lack of pre-printed equations is the only real difference between the Binary Quads Games and the Binary Challenge Games. The standard rules, procedures and forms used in playing Binary Quads Games still apply. Each players must use their personal knowledge of binary numbers, the Order of Operation and of mathematics in general to create accuracy equations or to determine the accuracy of another player's equation claim. BQ challenge players must also have a working knowledge of the Binary Coded Decimal number system so they can quickly determine the difference between binary numbers and decimal numbers. However, players in challenge matches can agree to special one time changes to the non-mathematically based rules for Binary Quads Games before the start of their matches.
The Game Master (GM)—The GM is the person who is responsible for directing the play of the game. This person may be a classroom teacher or another player who has exhibited an adequate level of knowledge of the math being used in a particular puzzle and knows the rules and procedures for playing the game. The GM directs the flow of the game, enforces the rules, keeps score and decides all claims and disputes between players.
   GMs must establish when a game will end at the beginning of the game, based on either a particular target score, the density of equations on the game board or some other determination. They must also determine the amount of time a players will have to submit a claim during their turn of play. The GM is required to take the skill levels of their players under consideration when establishing time intervals.
   INS/GM Answer Sheets will be provided, which contains all of the answers to a particular puzzle's Identity Questions.
   The GM will physically add valid new equations and any add-ons to existing equations to the game board after the end of each Challenger Claim Period. This period of time must be set before the game begins.
   The Game Master will be the final decider on all disputes between players, however, players have the right to challenge the GM's decisions by presenting evidence from the rules of the game or any other official mathematical related document.
Binary Quads Game Rules, Guidelines and Procedures—The main objective of Binary Quads Games is for players to obtain the most points by the end of the game. Player Can gain and lose points during the game by answering the Identity Questions of pre-printed puzzles, creating accurate new equations, or add-on to existing equations, and by winning equation challenge claims.
   Constructing Equations—Players may use Binary Coded Decimal numbers sequences, decimal numbers and various mathematic signs and symbols such as +, −, ×, ÷, π, °, ≦, ≧ and others to construct Binary Mixed Equations or traditional equations. All players must follow the established rules of mathematics such as the math Order of Operation when adding, subtracting, multiplying and dividing decimal and binary numbers in the creation of new Binary Mixed Equations and traditional equations, or when adding to existing equations. Player planning on using unique or advanced math equations must provide written support for their equation designs.
      A players can only change direction once during the creation of a new equation or when adding to a existing equation.
      Players may intersect and bisect another equation while adding to existing equations or creating new equations, however, the quad being intersected or bisected must become a functional part of the new add-on or equation.
Binary Quads Game Play—The players can begin the game after the GM has established the end of game criterion, recorded all of the player ID Tags and have set the time intervals for the player's turn of play and the Claim Challenge Period.
   The players will start the game by taking their turn in answering the Identity Questions, by creating or adding to equations. Each player gets one turn of play per round. However, a player may forfeit their turn of play if they are unprepared to answer a question or submit a claim during their turn. Players must make one IQ guess per turn and are penalized for incorrect guesses.
   Submitting Claims—Players can submit one Equation Claim Slip per turn before or after making their IQ guesses. After a player has submitted a Equation Claim Slip other players can challenge the correctness of all or parts of that claim by filling out one of the challenge lines on the Equation Claim Slip to identify their particular challenge. Additional Equation Claim Slips can be used and combined to submit longer equation claims. Challengers of a claim must submit their challenge before the third turn of the player making the original claim is reached. The winner of a claim challenge will be granted Challenge Points by the Game Master (GM) from the point total of the loser of the challenge equal to the total points of that equation. An IOU with the winning player's Tag will be place in the losing player's score column if points are not available for transfer. If a player submits an inaccurate add-on or new equation claim, or answer a Identity Question incorrectly the GM must deduct that number of points from the that player would have gained from their current point total. This process continues throughout the game until the designated ending of the game established by the GM has been reached, The game points are then added up and the GM declares the winner of the game.
Scoring Points
   Players submitting incorrect claims and challenges will lose points equal to the points related to the challenged claim.
   The available equation points are:
      One point for each quad in a new equation.
      Three points for each binary digit used.
      Five points for each Identity Question.
      Five points for each blank quad.
      Twenty points for each intersection or bisection.
   Challenge Points—Players after a equation claim challenge will either receive or lose the total Challenge Points of the challenged equation.

1. Binary mixed equations—I claim the invention and exclusive use of my new mathematical equation format that uses a binary coded decimal number sequences of ones (1) and zeros (0) to represent a decimal number within a traditional equation format, along with decimal numbers and various mathematical signs and symbols such as +, −, ×, ÷, π, °, ≧, ≦ and others signs and symbols to create a new, accurate and functional mathematically based equation format as described in this patent application:
Binary Quads Puzzle—I claim the invention and exclusive use of the unique Binary Quads Puzzle formats designed on a grid of quads like graph paper placed neatly within a polygon shape border, then constructed using a process that pivots a combination of Binary Mixed Equations and, or traditional equations at their starting points, then rotates each equations to a different angle from 0 to 360 degree and finally arrange this group of equations in a crisscrossing, intersecting and bisecting configuration of mathematically functional equations designed to teach student binary numbers, to practice basic math skills and to challenge the deductive and inductive reasoning of both students and adults as described in this patent application.
I claim the invention and exclusive use of all the Binary Quads Games and Binary School-Card formats I created using my Binary Mixed Equations and the related game boards, cards, slips and forms such as my Binary Quads Game Boards, Binary Quad Player's Cards, Binary-School Cards, INS/GM Answer Sheet, Tech-PreP Answer Sheet, Equation claim Slips, Player's Score Sheet and the complete array of Binary Quads Puzzle and game rules, guidelines and procedure described in this patent application.
